(19) United States
(12) Patent Application Publication
(10) Pub. No.: US 2009/0185685 A1
(43) Pub. Date: Jul. 23, 2009

(54) TRUST SESSION MANAGEMENT IN HOST-BASED AUTHENTICATION

(75) Inventors: Christopher V. DeRobertis, Hopewell Junction, NY (US); Robert R. Gensler, JR., Hyde Park, NY (US); Serban C. Maerean, Ridgefield, CT (US)

Correspondence Address: HESLIN ROTHENBERG FARLEY & MESITI P.C., 5 COLUMBIA CIRCLE, ALBANY, NY, 12203, US

(73) Assignee: INTERNATIONAL BUSINESS MACHINES CORPORATION, Armonk, NY (US)

(21) Appl. No.: 12/016,619

(22) Filed: Jan. 18, 2008

(51) Int. Cl. H04L 9/30; H04L 9/14

(52) U.S. Cl. 380/259; 380/277

(57) ABSTRACT

In a distributed, multinode data processing environment, computationally more intense public key cryptography is used to establish computationally less challenging symmetric key cryptographic paths which are thus enabled for longer term communication interchanges and in particular for establishing a client's network identity.

### TECHNICAL FIELD

The present invention is generally directed to secure communications in a multinode, distributed data processing system. More particularly, the present invention is directed to the use of asymmetric cryptography to establish a secure path protected via symmetric key cryptography. Even more particularly, the present invention is directed to a system and method for identifying a client's network identity in a distributed, multinode data processing environment.

### BACKGROUND OF THE INVENTION

In typical Reliable Scalable Cluster Technology (RSCT) environments, client-server authentication uses the so-called Host-Based Authentication (HBA) public key infrastructure to authenticate an application client to an application server. The HBA public keys are exchanged between hosts such that trust is established between them in order for the host accepting the application client's identity to trust the client's network identity provided to the application server by the host initiating the client authentication session.

It is noted, however, that public key cryptography is very computational intensive and, as a consequence, slow. In a large cluster environment, where performance scaling is important, the public key cryptography processing performed by the HBA mechanism often has a large performance impact. In contrast, symmetric key encryption, where the same or closely related keys, are used for both encryption and decryption are processed in times that are hundreds or even thousands of times faster than the algorithms required for asymmetric key processing, including public key processing.

In the present discussion, it is noted that the more generic term “symmetric key cryptography” is used rather than the term “private key cryptography” since the term “private key” is found in asymmetric or public key cryptography to distinguish it from the “public key” also found in this more complicated cryptographic system. Symmetric key cryptography, as that term is employed herein, is also sometimes referred to as “secret key” cryptography.

From the above, it is therefore seen that there exists a need in the art to overcome the deficiencies and limitations described herein and above.

### SUMMARY OF THE INVENTION

In accordance with a preferred embodiment of the present invention, a method is provided for identifying a client's network identity in a distributed, multinode data processing environment. The method comprises the steps of establishing, using public key cryptography, a trust relationship between a first node and a second node in the environment. The first node includes an application client and the second node includes an application server. Upon establishing the trust relationship between the first node (or host) and the second node, there is also established a symmetric key cryptographic system between the first node and the second node, for subsequent use by the cluster security infrastructure for the purpose of providing the application client's network identity to the application server. The application server is now particularly able to determine the client's network identity with a high degree of trust based only on symmetric key cryptography instead of asymmetric key cryptography.

In the present invention, the effect is thus to replace public key cryptography with symmetric key cryptography for the purpose of authenticating application clients to application servers, while at the same time maintaining the same high level of trust between the hosts in the cluster, as provided by public key cryptography. In short, computationally more intense public key cryptography is used to establish computationally less challenging symmetric key cryptographic paths which are thus enabled for longer term communication interchanges. In the present invention a symmetric key is used for establishing the identity of an application client to the application server, that is, it is used to create a secure context between the two. This is in contrast to systems employing a combined shared key which is used to provide message authentication, only after the identity of an application client is established, to the application server (in other words, once the secure context between the client and the server has already been established).

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWING

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a block diagram of illustrating the components of host systems employed in the establishment and utilization of symmetric key protected communication paths which are only established and used after more computationally challenging public key paths are employed in structuring security in the symmetric key protected paths.

### DETAILED DESCRIPTION

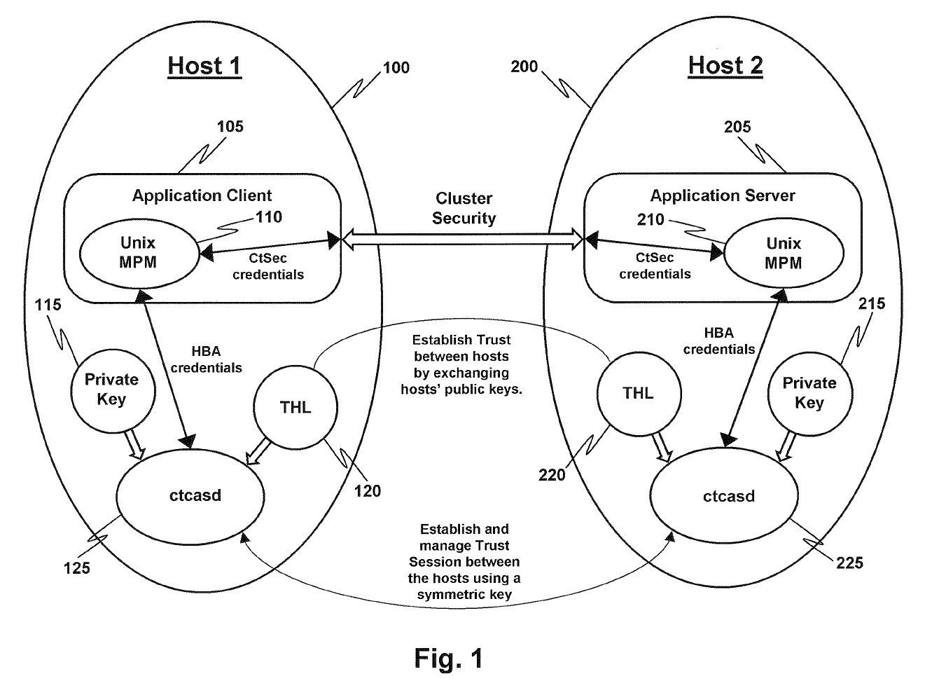

In the discussion below there is a description of the Host-Based Authentication (HBA) security mechanism as employed herein. In particular, in FIG. 1, there are two hosts, Host 1 (100) and Host 2 (200), that establish trust between themselves by exchanging their respective HBA public keys, as shown. Application client 105, trying to authenticate to application server 205, acquires a network identity from ctcasd daemon 125 (which implements HBA) in the form of a context control data buffer (CCDB, not shown). Application client 105 then sends this CCDB information to application server 205 which, in turn, sends it to daemon 225 for the purpose of authenticating the application client's identity. (A daemon is a program that runs in the background with respect to an application program user and is typically employed to respond to various events or requests.) The ctcasd daemons 125 and 225 both employ a Trusted Host List (THL), 120 and 220 respectively, to facilitate the exchange of public key information. The THL file is created during initial installation and configuration of the cluster and it is initially populated with the public key of the local host only. When the public keys are exchanged, the THL file is updated with the remote host's public key. During the process of authenticating the client's identity, HBA uses public key cryptography. In both of the hosts shown it is indicated that application clients 110 and 210 communicate with the ctcasd daemon through the MPM facility (MPM stands for Mechanism Plug-in Module and it allows the Mechanism Abstract Layer (MAL) to load different modules to handle specific security mechanisms like Kerberos 5 and HBA) 110 and 210 respectively. Similar facilities exist in other operating systems and the present invention is not so constrained as to be limited to any one particular operating system.

As a result of the authentication process, a security context is established between application client 105 and application server 205. The security context provides a client network identity to server 200 and session (symmetric) keys 115 and 215 for the purpose of signing/encrypting subsequent messages exchanged between application client 105 and application server 205.

A significant aspect of the present process is the fact that HBA (which the ctcasd daemons implement) uses public key cryptography in order to create the security context between application client 105 and application server 205. As mentioned above, the HBA public key establishes trust between the hosts for the purpose of determining a client's network identity. The gist of the present invention is to replace the public key cryptography used for the purpose of authenticating a client or server, with subsequent interchanges involving symmetric key cryptography. In other words, the present idea is to create a trust session between the hosts that use symmetric keys (and symmetric key cryptography) instead of public keys (and asymmetric key cryptography). Basically, the hosts where the application clients and servers run establish and manage trust sessions that expire and are renewed at preset intervals, or as otherwise required. Once a trust session is established, symmetric key cryptography is used in place of asymmetric key cryptography for the purpose of determining the clients network identity.

The HBA security mechanism uses a symmetric session key within a security context. SSH and SSL do the same. SSH stands for “Secure SHell” and SSL stands for “Secure Socket Layer.” SSL has an option to use asymmetric key cryptography in order to establish a secure connection between a client and server. The secure context created is defined by a session key. SSH uses SSL under the covers. This is all done for the purpose of using the asymmetric key cryptography (which is very slow compared to the symmetric key cryptography) for as little time as possible. The utility and advantages of the present invention lie in the fact that, in a distributed security mechanism, trust sessions based on symmetric keys are used for the purpose of determining a session's client's network s identity.

There are other security mechanisms, such as Kerberos 5, that use symmetric keys for both client authentication and session key, however, Keberos 5 uses a centralized key distribution center and does not use trust sessions. In contrast, HBA is implemented as a distributed security mechanism. By establishing and managing trust sessions using symmetric keys, the performance of authenticating the application client to the application server (and vice-versa, for mutual authentication) increases dramatically, from the scale of tens of milliseconds to mere microseconds (excluding network latency and resource availability delays).

The implementation of such an idea is fairly simple taking into consideration the existing infrastructure. During the first client-server authentication between two hosts, the ctcasd daemons on each of the hosts establish a trust session between the two hosts with an associated symmetric key. That symmetric key is used to process the data exchanged for the purpose of client/server authentication and for the creation of a security context between the application client and the server. Each daemon maintains the trust session until it expires or until one of the daemons is restarted, in which case a new trust session is established (with a new and different session key).

Some performance impact is expected during the establishment of a trust session. However, that should happen only once in a while (when the trust session expires or when one of the hosts is restarted). The performance gained subsequently by replacing the asymmetric key cryptography with the symmetric key cryptography is more than enough to justify such a once-in-a-while performance penalty.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

What is claimed is:

1. A method of identifying a client's network identity in a distributed, multinode data processing environment, said method comprising the steps of:
establishing, using public key cryptography, a trust relationship between a first node and a second node in said environment, said first node having at least one application client and said second node having at least one application server;
upon establishing said trust relationship between said first node and said second node, establishing a symmetric key cryptographic system within said first node and said second node, for the purpose of managing trust sessions for the trust relationship established between said nodes; and
communicating between said at least one application client and said at least one application server via said symmetric key cryptography system to determine client network identity using the trust session managed by said symmetric key.

2. The method of claim 1 in which said symmetric key cryptographic system is employed to establish a plurality of client-server sessions.

3. The method of claim 1 in which each node contains a public key list which includes a public key associated with each node, respectively.

4. The method of claim 3 in which said list is updated during the process of establishing said trust relationship.

5. The method of claim 4 in which said updating includes adding public key information for other nodes in said environment.

6. The method of claim 1 in which said communication is carried out through a daemon running on one of said nodes.

7. The method of claim 1 in which establishing said trust relationship employs private cryptographic keys contained within said nodes.

8. The method of claim 1 further including, in the event of an expiration of said trust relationship, reestablishing said relationship using public key cryptography.

9. The method of claim 1 further including, in the event of a node restart, reestablishing said relationship using public key cryptography.

10. The method of claim 1 in which, during a first client-server authentication between two nodes, a daemon on each of the nodes establishes a trust session between the two nodes with an associated symmetric key.

11. The method of claim 1 in which there are a plurality of nodes and in which any of said trust relationships are established between pairs of said nodes.

12. The method of claim 11 in which said trust relationships are established between all pairs of said nodes.

13. A method for identifying a client's network identity in a distributed, multinode data processing environment, comprising using computationally more intense public key cryptography to establish computationally less challenging symmetric key cryptographic paths which are thus enabled for longer term communication interchanges.

14. A multinode data processing systems include program instructions therein for identifying a client's network identity using computationally more intense public key cryptography to establish computationally less challenging symmetric key cryptographic paths which are thus enabled for longer term communication interchanges between said nodes.

15. The multinode data processing system of claim 14 in which said symmetric key cryptographic paths establish a plurality of client-server sessions.

16. The multinode data processing system of claim 14 in which each node contains a public key list which includes a public key associated with each node, respectively.

17. The multinode data processing system of claim 16 in which said list is updated during a process of establishing a trust relationship.

18. The multinode data processing system of claim 17 in which said updating includes adding public key information for other nodes in said system.

19. The multinode data processing system of claim 14 in which daemons are provided in said nodes to establish said computationally less challenging symmetric key cryptographic paths.

20. The multinode data processing system of claim 19 in which said daemons also enable said longer term communication interchanges between said nodes.
